(19) United States
(12) Patent Application Publication
(10) Pub. No.: US 2007/0094062 A1
(43) Pub. Date: Apr. 26, 2007

(54) Apparatus and method for long range planning and implementation of digital subscriber network

(75) Inventors: Robert Tracy, Dublin, CA (US); Melissa Johnson, Frisco, TX (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/259,460

(22) Filed: Oct. 26, 2005

(51) Int. Cl. G05B 19/418; G07G 1/00; G06F 17/50; G06F 15/177; H04L 12/28

(52) U.S. Cl. 705/8; 705/10; 709/220; 370/254; 703/13

(57) ABSTRACT

A method is provided for designing a communications network. A variation of parameters is introduced into a set of parameters located in at least one of a plurality of databases related to the communications network. A set of business rules is applied to the varied set of parameters in order to produce a business projection. An evaluation is made of the business projection that results from applying the business rules to the variation. Evaluating the business projection includes comparing the business projection to an actual business outcome. Further changes may be made to the varied set of parameters based on the comparison of the business projection to the actual business outcome. A communication network may be designed in line with the business projection. Statistics are calculated that relate to a business objective.

### BACKGROUND OF THE INVENTION

1. Field of the Invention

The present invention relates to the field of communications network planning and more particularly to a method and system for implementing a projected network plan and evaluating the projected network plan with actual network usage.

2. Description of the Related Art

Demand for communication services, such as Internet service via a Digital Subscriber Loop (DSL), Voice over Internet Protocol (VoIP), Internet Protocol based Television (IPTV) and Video On Demand (VoD) has been growing at a fast rate and is expected to grow even faster in the next several years. The costs for creating new networks to provide these additional services are prohibitive. It is more likely that network providers will search for ways to grow their existing network systems that are economically feasible.

To grow a communication network requires knowledge of, among other things, market potential, market penetration rates, current inventory levels of equipment and their capabilities, equipment costs, and bandwidth requirements. These parameters are generally used to determine goals for network growth and associated costs. The ability to provide a long range plan for growing a communication network enables a business planner to monitor progress towards the achievement of goals during a given growth period. Monitoring may be performed in real time rather than at the end of a growth period. Due to the complexity of the computations involved, prior methods for estimating annual budget needs and growth goals have been manually intensive and have tended to take different forms with each growth cycle.

The present invention provides a method and system of applying a repeatable and documented set of business rules to a financial planning segment of a communications network company and developing a building plan that is directly linked to a projected growth. The present invention also provides the ability to track the progress of development and to be proactive in addressing cost underruns and overruns.

### SUMMARY OF THE INVENTION

The present invention provides a method of designing a communications network. A variation of parameters is introduced into a set of parameters located in at least one of a plurality of databases related to the communications network. A set of business rules is applied to the varied set of parameters in order to produce a business projection. An evaluation is made of the business projection that results from the business rules being applied to the variation. Evaluating the business projection includes comparing the business projection to an actual business outcome. Further changes may be made to the varied set of parameters based on the comparison of the business projection to the actual business outcome. A communication network may then be designed in line with the business projection. The present invention includes calculating statistics related to a business objective. Some examples of statistics include discount rates, inventory, market penetration rates, market size, bandwidth requirements, desired growth, etc.

In another aspect, the invention provides a computer readable medium that has embedded therein a computer program accessible to a computer or processor wherein the computer program includes instructions to receive a forecast or demand over a selected time period, instructions to receive information about a plurality of network elements, including capability or capacity and cost of each such element. The computer program may include instructions to receive a current inventory of the network elements and one or more business rules. The program further may include instructions to generate a network plan or projection that is based on the current inventory, forecast, one or more business rules, costs and capacities of the network elements. The computer program also may include instructions to generate a number of displays or worksheets. The computer program further may include instructions to evaluate the implemented network based on the network plan and the actual usage of the network to alter the network plan.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For detailed understanding of the present invention, references should be made to the following detailed description of an exemplary embodiment, taken in conjunction with the accompanying drawings, in which like elements have been given like numerals.

FIG. 1 (Prior Art) illustrates an exemplary communications network that may be implemented according to one aspect of the present invention;

FIG. 2 illustrates a system for calculating a projection usable in designing a communications network;

FIG. 3 illustrates a diagram of an exemplary Long Range Planning Tool for collecting input data and determining a business projection related to a communications network;

FIG. 4 illustrates a flowchart indicating a method for producing a set of business projections related to growth of a communications network;

FIG. 5 illustrates an example of Assumptions Worksheet that displays several threshold values related to equipment used in design of a communications network;

FIGS. 6 and 7 illustrates an example of an Annual Summary Worksheet that provides a forecast of capital expenditures and network equipment necessary to meet a projected annual growth of a communications network;

FIGS. 8 and 9 illustrates an exemplary Capital Summary Worksheet that projects monthly expenditures and equipment implementation rates by region;

FIGS. 10-13- illustrates a Statistics Summary worksheet displaying projected values of various network statistics resulting from implementing a business projection;

FIG. 14 illustrates an exemplary Actuals worksheet displaying actual statistics on parameters related to growth of a communications network;

FIGS. 15-18 illustrates an exemplary Annual Growth worksheet that provides detailed calculations of various network growth statistics related to regional growth of the communications network;

FIG. 19 illustrates an exemplary Forecast worksheet providing an initial estimate of growth in subscriber base used to derive projected growth parameters; and

FIG. 20 illustrates a BRAS pricing worksheet providing purchasing costs of equipment used in a communications network.

FIG. 21 is a diagramatic representation of an embodiment of an computer system for use in executing the methods of the invention.

### DETAILED DESCRIPTION OF THE INVENTION

In view of the above, the present invention through one or more of its various aspects and/or embodiments is presented to provide one or more advantages, such as those noted below.

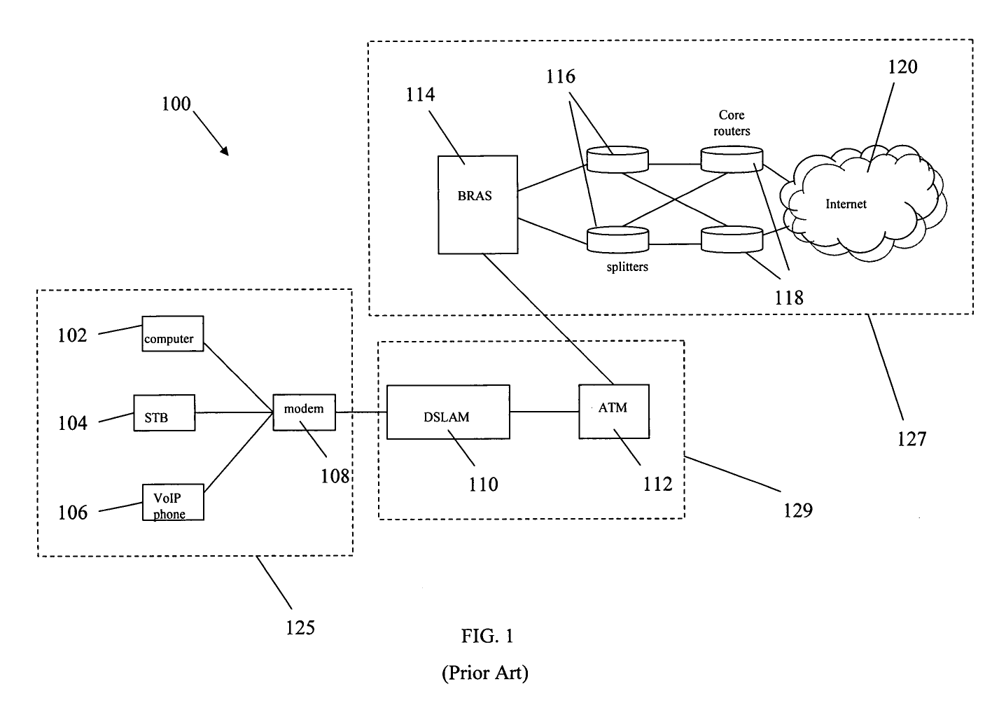

FIG. 1 illustrates an exemplary communications network 100 that may be implemented according to one aspect of the present invention. The communications network may include a Customer Premises Equipment (CPE) section 125, a Transport Section 129, and a Core Network section 127. In general, the CPE section 125 may connect to the Core Network section 127 via network devices located in the Transport Section 129. A CPE section 125 may include one or more terminal devices used for a providing a service from the core network 127 to the customer. Such terminal devices may include, for example, a computer 102 for providing an Internet connection, a set top box (STB) 104 for providing IPTV service, and a VoIP phone 106 for providing phone service using Internet Protocol. The CPE section 125 may also include a device which provides a central connection between the various terminal devices and the Core Network Section 127. One such device could be a DSL (Digital Subscriber Line) modem 108 providing a connection to the network. The connection may be provided over copper wires used for existing telephone service. Various fiber optic equipment, such as a Digital Signal 3 (DS-3) circuitry generally transmitting at 44.736 Mbps, or Optical Carrier 3 (OC-3) circuitry that transmits data at a general rate of 155.52 Mbps, may also be utilized to provide connectivity, such as between transport network 129 and CPE 125.

A typical Core Network section 127 may provide service over a wide geographical area, such an area of 400 to 500 miles in diameter, in which multiple CPE sections reside to provide service subscribers. A Core Network may have multiple transport sections associated with it, to provide connectivity to the multiple CPE sections. The Transport Section 129 of communication network 100 includes various devices for providing connections between these many CPE sections 125 within the geographical area and the Core Section 127 serving the geographical area. An exemplary Transport Section 129 may include a DSLAM (Digital Subscriber Loop Access Multiplexer) 110 and an Asynchronous Transfer Mode (ATM) network 112. A DSLAM is a packet multiplexer capable of multiplexing the data packets from multiple customers in order to transmit them over one or more high-speed circuits. In an integrated voice/data DSL network, the voice packets may be forwarded to the Public Switched Telephone Network (PSTN), or to an Internet Protocol (IP) voice network, while data packets are forwarded to the Internet, often over an ATM-based data network. The DSLAM is generally located at a wire center or central office, also referred to as a Point-of-Presence (POP). A wire center typically refers to a point of aggregation for regional traffic. Often a single wire center can serve a local region. Larger regions, such as Los Angeles or Houston, may use multiple wire centers. The DSLAM 110 may transfer data to and from the ATM (Asynchronous Transfer Mode) network 112. The ATM network transfers data in cells or packets of a fixed size.

Core section 127 provides several devices for routing data aggregated from the CPE sections 125 over large portions of a network. A typical core network may include a Broadband Remote Access Server (BRAS) router 114, a series of distribution switches 116, and core routers 118 providing connectivity to Internet 120. BRAS router 114 routes traffic between the DSLAM 110 and the core network and aggregates user sessions from the multiple DSLAMs. An operator, through access to the BRAS router, may be able to address policy management issues and IP Quality of Service (QoS) issues. For areas with a large subscriber base, multiple BRAS routers may be utilized. Some exemplary BRAS routers include a Redback 1800 BRAS router, a Redback 10k BRAS router, a Juniper ERX router, and Juniper 1410 BRAS router.

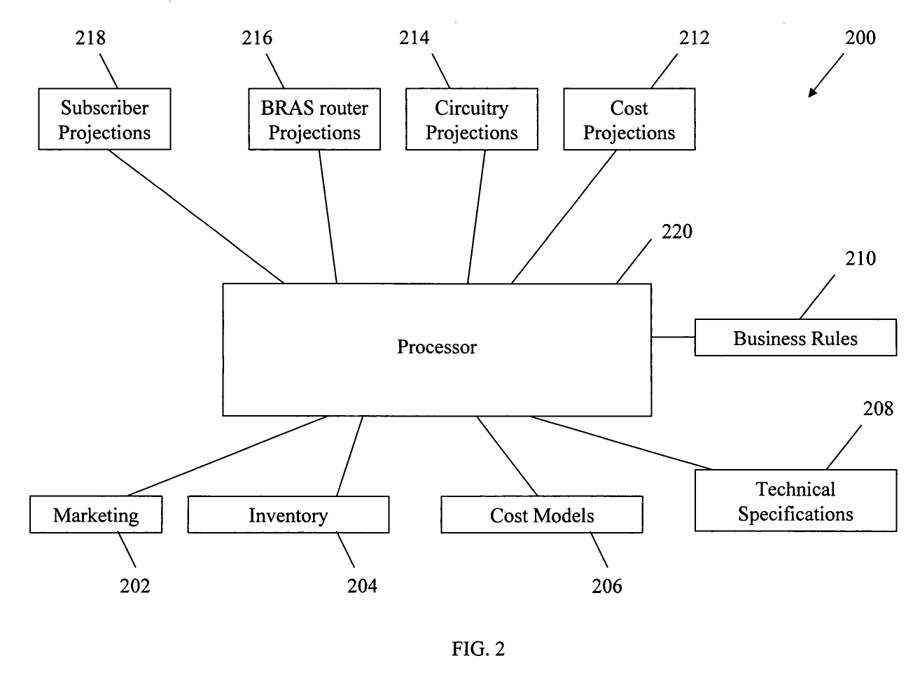

FIG. 2 illustrates a system 200 of input databases and calculated projections that may be used when implementing a communications network. The input databases provide parameters useful in calculating the projections. An exemplary group of input databases relate to, among other things, marketing data 202 (subscriber base, forecast of growth, bandwidth use, etc.), inventory levels 204, cost models of equipment 206 (including discounts, regional pricing, etc.), and technical specifications of network equipment 208, such as equipment capacity. Some databases commonly used in the industry include a Circuit Detail Tool (CDT) database that provides actual levels of use of DS3 (Digital Signal 3) and OC3 circuit elements; a Pulse of Business (POB) database that provides parameters related to DSL subscriber growth rate; a Cost Models database that provides data relates to costs of various network equipment; a Ready For Service (RFS) database that provides inventory and implementation levels of various network equipment; a Loman Report providing official monthly capital statements; and an Adlex system providing information on bandwidth usage at regional wire centers. A marketing forecast may also be used as input. A business rules database 210 may be used to calculate projections from parameters drawn from one or more input databases. An input database may be operated by different groups within a business organization, such as a network engineering group or a financial planning group. A computer processor 220 applies business rules to the one or more input databases to calculate one or more projections concerning growth of the communication network. These projections may include, for example, projected growth in subscriber base 218, projected growth in the number of network equipment 216, projected growth in the amount of circuitry equipment 214, projected cost of implementing the communication network 212, etc.

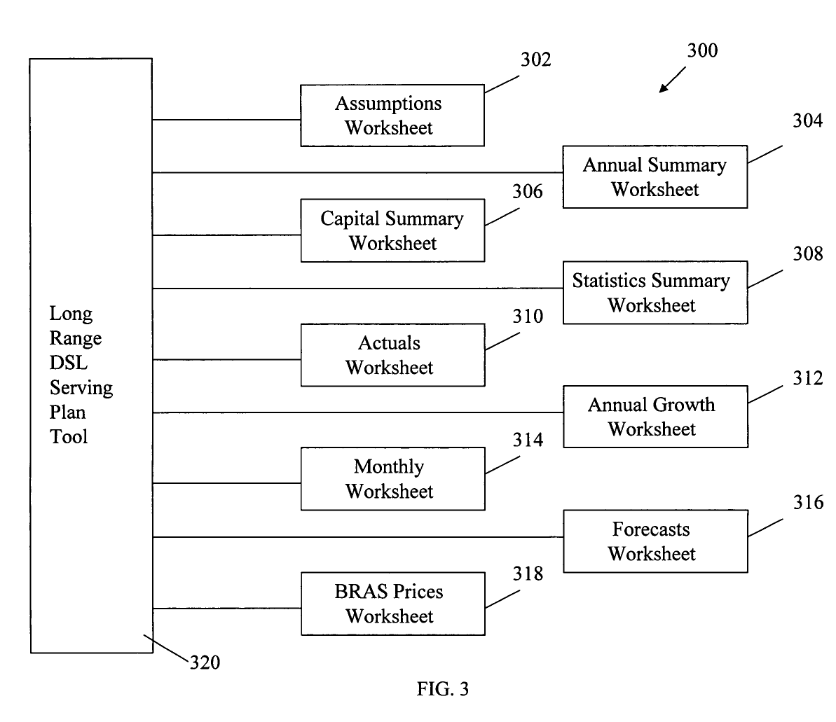

FIG. 3 illustrates a diagram 300 of an exemplary Long Range Planning Tool 320 of the invention useful for determining a business projection from collected input data. In one aspect of the invention, the Long Range Planning Tool 320 may apply business rules the various input databases to create a business projection. The Long Range Planning Tool may provide an estimation of costs and projected revenues for increasing a DSL subscriber base both globally and at a given wire center. An operator may use the Long Range Planning Tool to test several outcomes given certain forecasts, thereby reducing trial-and-error network growth. Additionally, an operator may store actualized data concerning network status (i.e., the number of BRAS routers actually implemented, etc.) with the Long Range Planning Tool and compare the actualized data with previously projected data in order to chart a progress report.

The Long Range Planning Tool uses one or more spreadsheets to perform calculations. In an exemplary embodiment of the invention, the one or more spreadsheets may be an Excel spreadsheet and include several worksheets and function blocks. An Assumptions worksheet 302 includes tunable parameters that may appear in various formulas. An exemplary tunable parameter may include a threshold parameter that indicate utilization levels of various equipment. For example, a fill capacity of a BRAS router indicates a pre-defined number of subscribers on a BRAS router above which a new BRAS router is to be implemented to handle traffic. An Annual Summary worksheet 304 generally provides details on capital expense levels and equipment implementation levels necessary to provide service in line with a projected subscriber growth rate. A Capital summary worksheet 306 displays calculated projections and Actuals (e.g., actualized revenues, actualized expenses, actualized subscriber growth, etc.) for various parameters in order to provide a timely comparison of actualized data to projected data. A Statistics summary worksheet 308 documents projected and actual monthly growth of various network statistics, such as, a number of DSL subscribers, a number of BRAS routers, an amount of OC3 circuitry. Comparisons may be made within the Statistics summary worksheet between projected and actualized growth trends. If actualized growth is not consistent with projected levels, adjustments may be made in implementation methods.

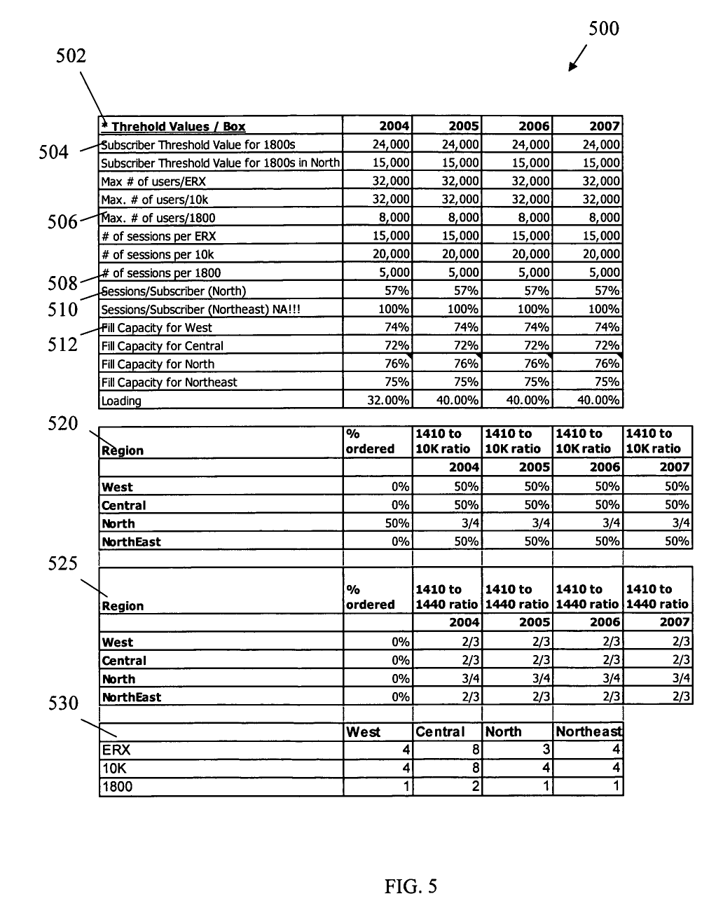

An Actuals worksheet 310 receives actualized business data such as an actual dollars spent in a month, an actual number of new DSL customers in a month, an actual number of new BRAS per month, an actual number of new OC3 circuits, etc. An Annual Growth worksheet 312 provides regional detail useful for determining regional growth requirements. An Official Marketing Forecast (provided in Forecast worksheet 316) is an input combined with various assumptions and formulas. Monthly worksheets 314 (i.e., Jan, Feb, Mar, etc.) record the Actuals data at the end of each month as the calendar year progresses. The monthly worksheets enable graphing of trends for the various statistics (i.e., capital dollars, BRAS hardware, OC3 circuits, etc.) collected and charted at each wire center. A Forecasts worksheet 316 provides a forecast, such as an Official Marketing Forecast of DSL growth that may be useful to for deriving projections. A BRAS Prices worksheet 318 provides a cost model on various network equipment, which can vary by supplier, region, device, etc. Details of exemplary worksheets of the Long Range Planning Tool 320 are shown in FIGS. 5-12 for the purposes of illustrating the present invention.

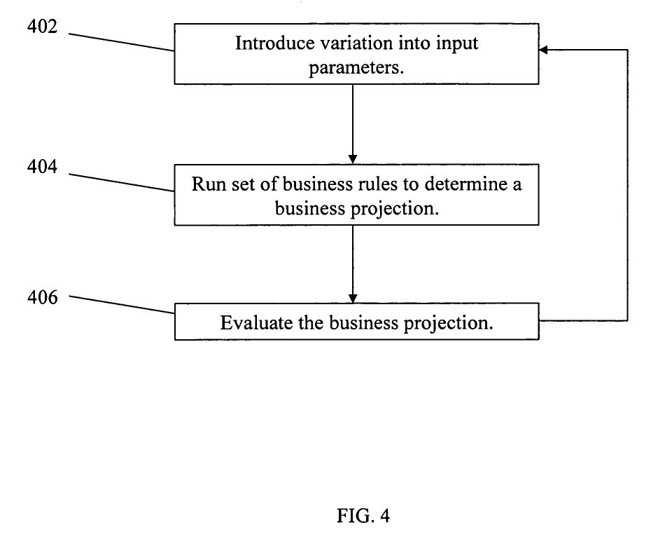

FIG. 4 illustrates a flowchart 400 for producing a business projection describing growth of a communications network. In general, a set of business rules may be applied to a set of input parameters to produce a business projection. A new parameter, or change in parameter value, may be introduced (Box 402). In Box 404, an operator applies a set of business rules to the parameters. The applied business rules determine a business projection (Box 406). The evaluation may be made by comparing the projection to Actuals, which are generally input on a monthly basis. The results of the comparison may then be used to revise the variation on the selected input parameter. The operator may choose to vary input parameters based on adherence of the resulting business projections to a desired actual outcome. Alternately, the operator may accept the projection and underlying input parameters. The operator may optionally return to Box 402, where another variation may be introduced.

An operator may use the Long Range Planning Tool to project customer growth and equipment requirements and thereby to plan and track the installation of hardware, such as BRAS routers, OC3 circuitry. The present invention may also be used to track growth trends for a plurality of wire centers and BRAS routers. The present invention may further be used to project an annual growth in network elements and finances based on a forecast of customer growth. An operator may thus be proactive when actualized business outcome does not match a business projection. For instance, an operator may return a dollar amount to a funding department of an organization or request more money from the funding department, as appropriate. Long range planning becomes standardized and may be verified against actualized growth.

FIG. 5 illustrates an exemplary Assumptions Worksheet 500 that displays several tunable parameters related to equipment useful in calculating a business projection. Section 502 includes threshold and operational values for several BRAS routers, circuitry, etc., including a Subscriber Threshold Value 504, a maximum number of users per BRAS router 506, a maximum number of sessions on a BRAS router 508, a maximum number of sessions per subscriber 510, and a regional fill capacity 512. These parameters are set by either technical specification or by business decisions and govern how to use the network equipment. In general, a new BRAS router is introduced into the network once the usage level of currently deployed BRAS routers exceeds a selected fill capacity value (such as 75%). Sections 520 and 525 track regional statistics on BRAS routers. Section 520 tracks a ratio of 1410 routers to 10 k routers. Section 525 tracks a ratio of 1410 routers to 1440 routers. Section 530 itemizes the use of each router by region.

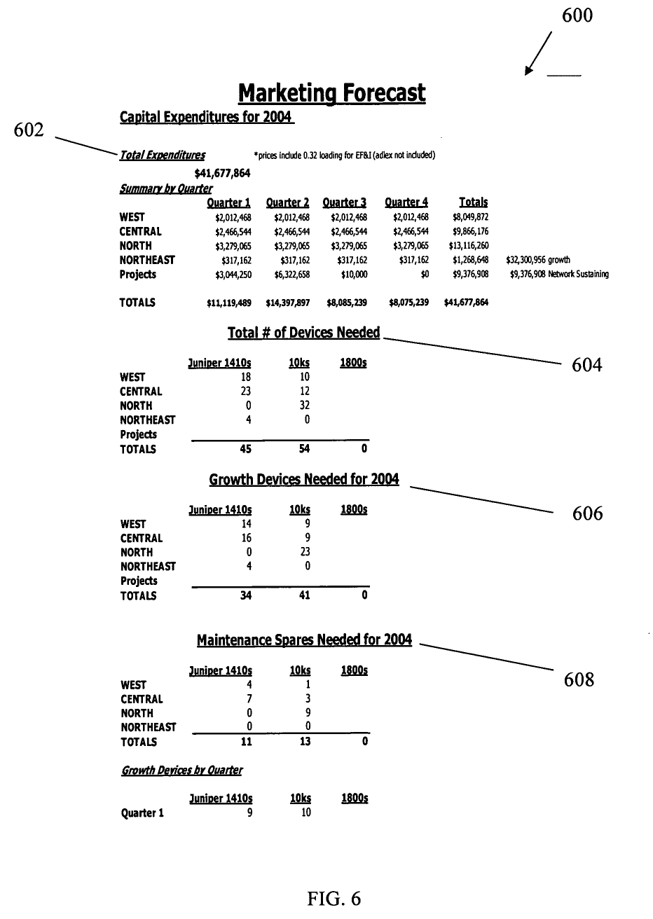

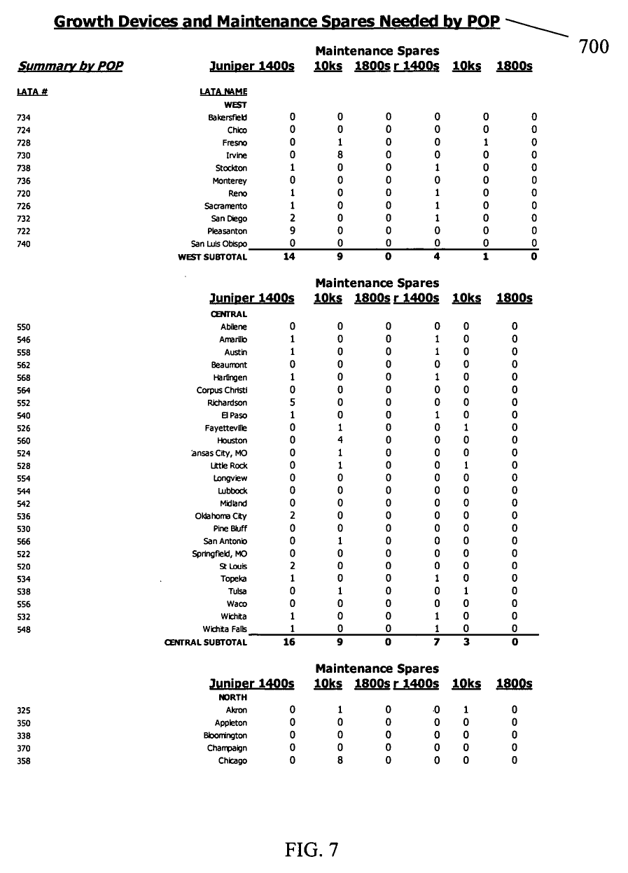

FIGS. 6 and 7 illustrates an exemplary Annual Summary Worksheet 600 that provides a forecast (“Marketing Forecast”) of capital expenditures and network equipment level necessary to accommodate a growth rate of a communications network. Total projections 602 and quarterly expenditures by region (i.e., West, Central, North, Northeast) are displayed. Projections for the amount of network equipment (such as BRAS routers) needed are displayed under sections titled “Total Number of Devices Needed” 604, “Growth in Devices Needed” 606, and “Maintenance Spares Needed” 608. A list of spare BRAS routers needed is listed according to wire center under “Growth Device and Maintenance Spares Needed by POP” 700 in FIG. 7.

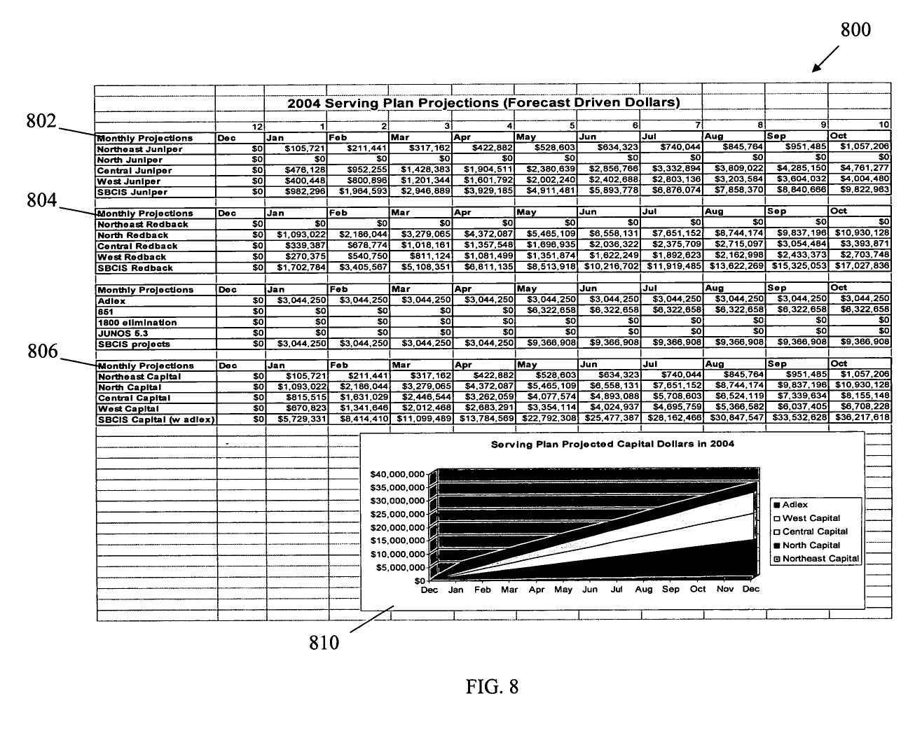

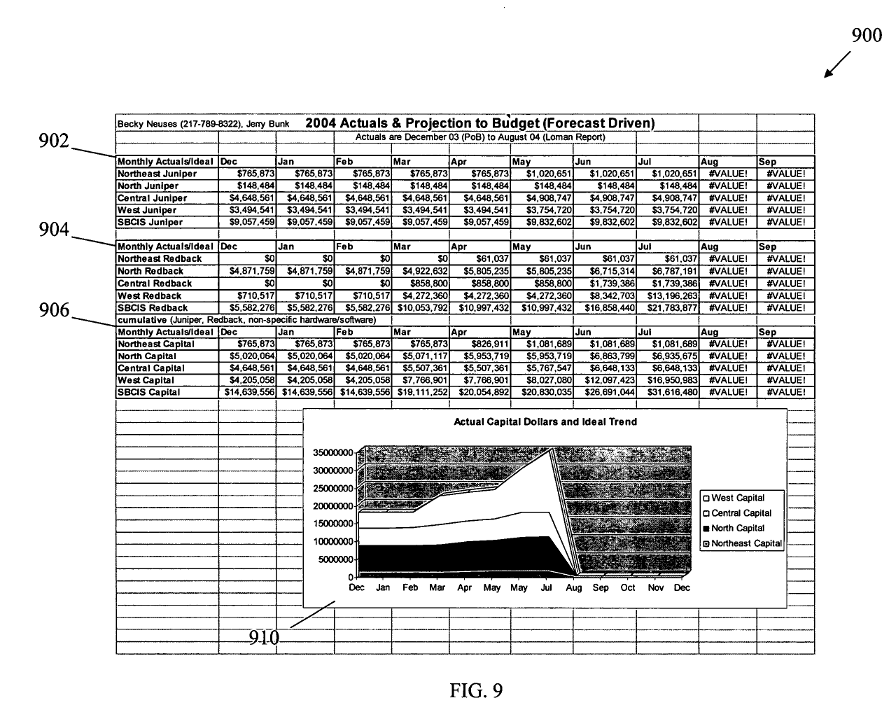

FIGS. 8 and 9 illustrates a section of an exemplary Capital Summary Worksheet 800 that summarized regional expenditures projections and compares projected implementation levels and actualized implementation levels. In FIG. 8, Section 802 displays projected monthly spending (in dollars) on Juniper BRAS routers. Section 804 displays a projected monthly spending (in dollars) on Redback BRAS routers. Section 806 displays a total spending for all routers. Graph 810 displays the spending trend according to the projected plan.

FIG. 9 illustrates another section of the Capital Summary worksheet 800 detailing actualized business expenditures 900. Section 902 displays a actualized monthly spending (in dollars) on Juniper BRAS routers. Section 904 displays actualized monthly spending (in dollars) on Redback BRAS routers. Section 906 displays total spending for both Juniper and Redback routers and may be obtained by adding corresponding entries in sections 902 and 904. Graph 910 illustrates the actual expenditure trends. An operator may compare the entries for Section 806 and the entries for Section 906 in order to determine, for example, an effectiveness of a projection or budget, cost overrun, etc. As an example, in Section 806, a projection is made for spending approximately $28 million for July 2004. In the corresponding entry in Section 906, $32 million dollars have already been spent at the end of July 2004. Thus, the department spending is over budget, sending the operator to seek reasons for the overrun.

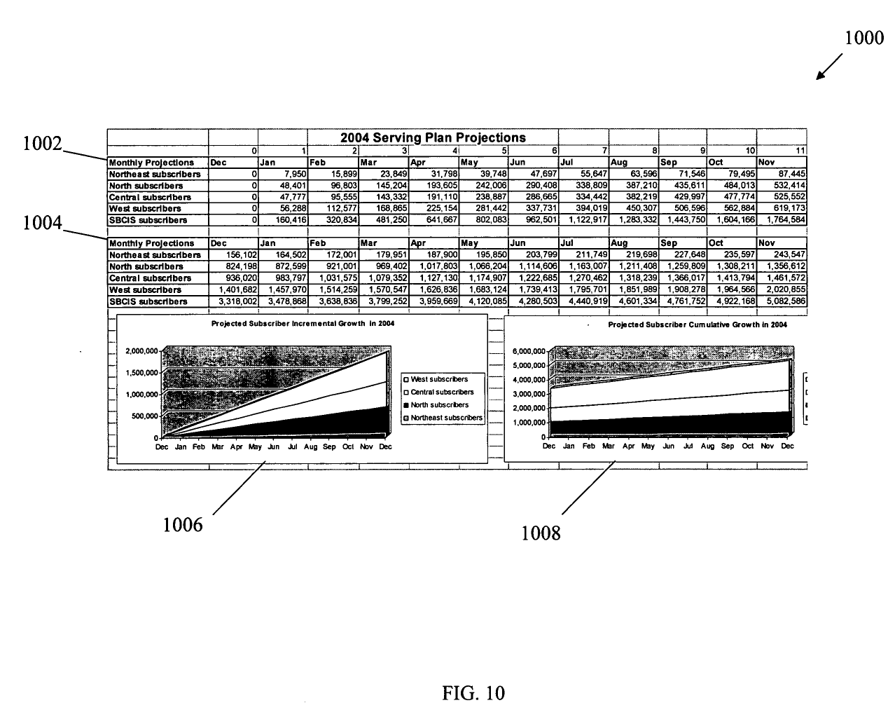

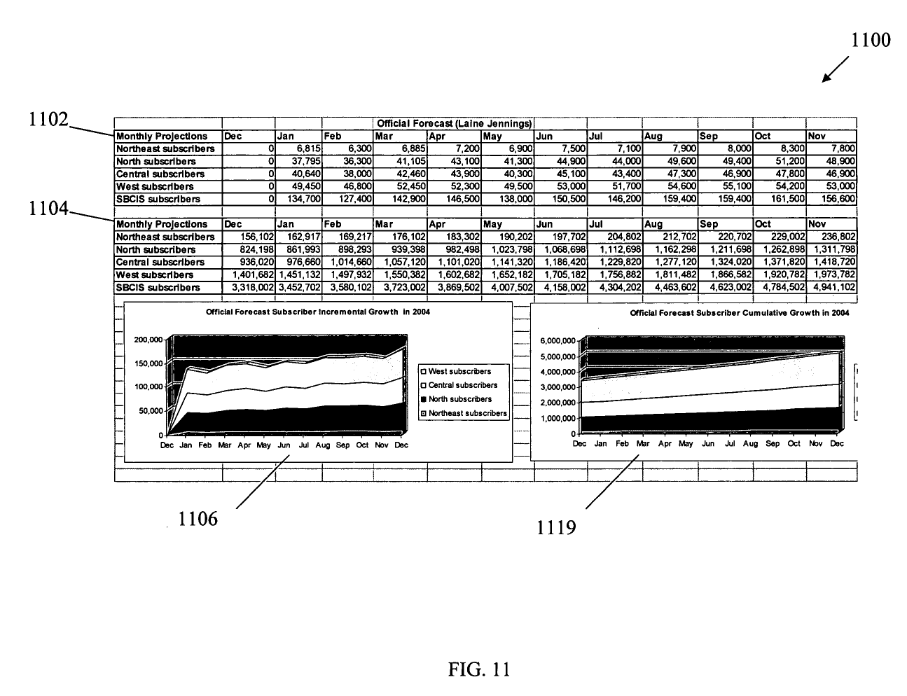

FIGS. 10-13 illustrates a Statistics Summary worksheet that displays projected values of various network statistics resulting from implementing a business projection. Some network statistics include a number of DSL subscribers, a number of BRAS routers, an amount of OC3 circuitry, etc. FIG. 10 illustrates a business projection of subscriber growth 1000. Section 1002 displays a projected incremental monthly growth of subscribers, and Section 1004 displays a total projected monthly subscriber base. Graph 1006 illustrates the projected subscriber incremental growth of Section 1002, and Graph 1008 displays the projected subscriber base of Section 1004. FIG. 11 illustrates an individual projection of subscriber growth. Section 1002 displays a projected incremental monthly growth of subscribers and Section 1104 illustrates a projected total subscriber base. Graph 1116 displays incremental growth values of Section 1102, and Graph 1118 displays cumulate growth values of Section 1104. In one aspect of the invention, the projections of FIG. 10 and FIG. 11 may be compared to determine discrepancies between projections.

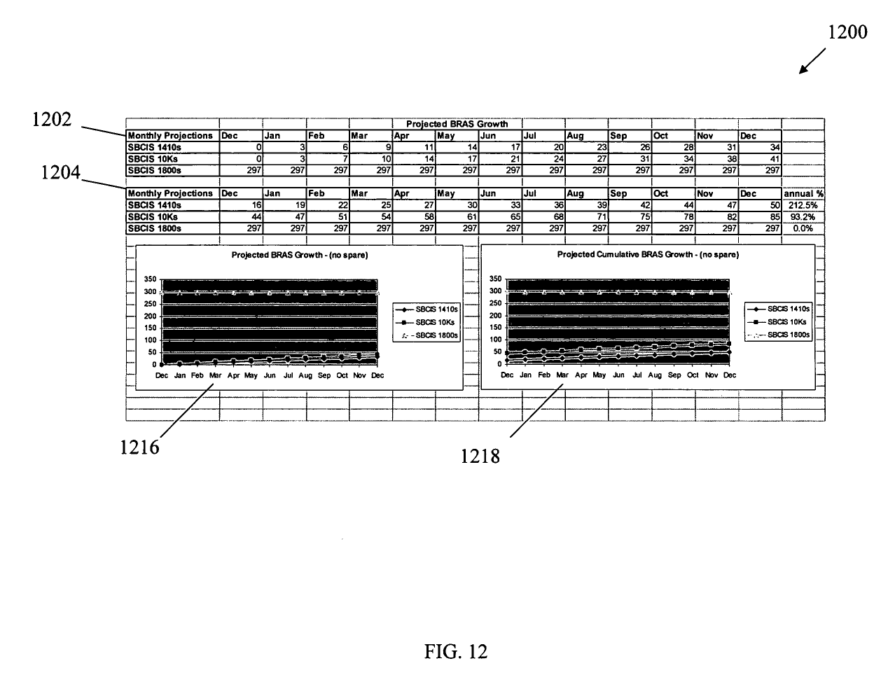

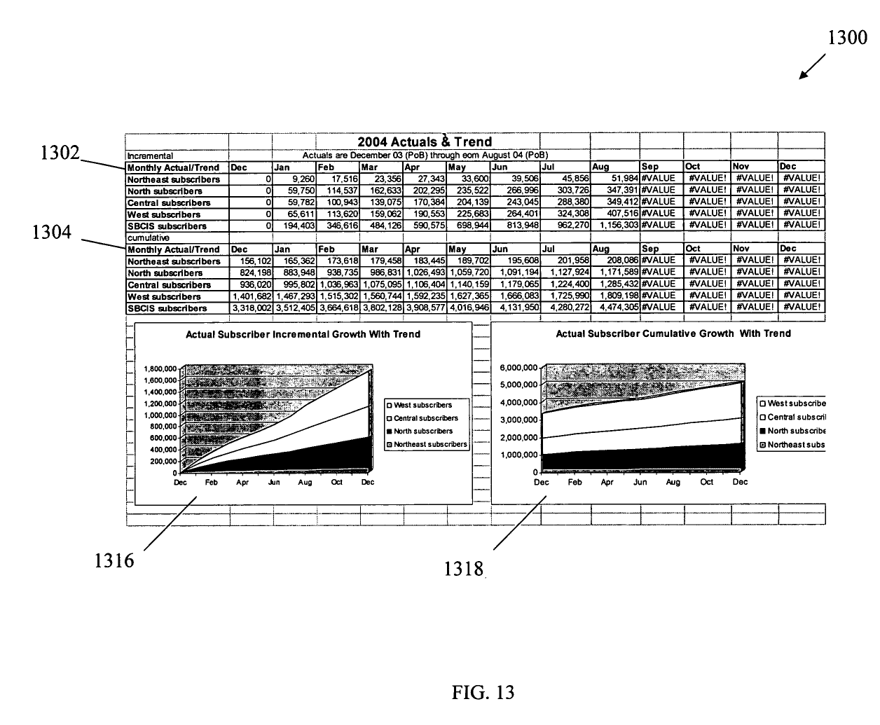

FIG. 12 illustrates a monthly projection of a growth of BRAS routers needed in order to implement a network growth projected. Section 1202 displays a projected incremental monthly increase in the number of BRAS routers and Section 1204 displays a projected total number of BRAS routers. Graph 1206 illustrates the projected increase in BRAS routers of Section 1202, and Graph 1208 illustrates the projected cumulative BRAS growth of Section 1204. FIG. 13 illustrates an actualized number of additional subscribers 1300. Section 1302 displays an actualized number of subscribers added by month, and Section 1304 displays an actualized total accumulation of subscribers by month. Graph 1306 illustrates the incremental growth of subscribers of Section 1302, and Graph 1308 illustrates the cumulative subscriber base of Section 1304.

Actual growth figures may be compared to projected figures. In one aspect of the invention, the comparison may be made in order to determine the effectiveness of the projection and business plan. In another aspect of the present invention, an operator may vary an input parameter to vary projection estimates. Multiple variations may be run, and a best fit of projections to actual trends may be selected. The variation of input parameters that best fits actual trends may then be studied. Typically an operator may use the present invention to spot differences between projected growth rates and actual growth rates. Any differences may be noted to identify problems that may have occurred during implementation, false assumptions in the projection calculations, etc.

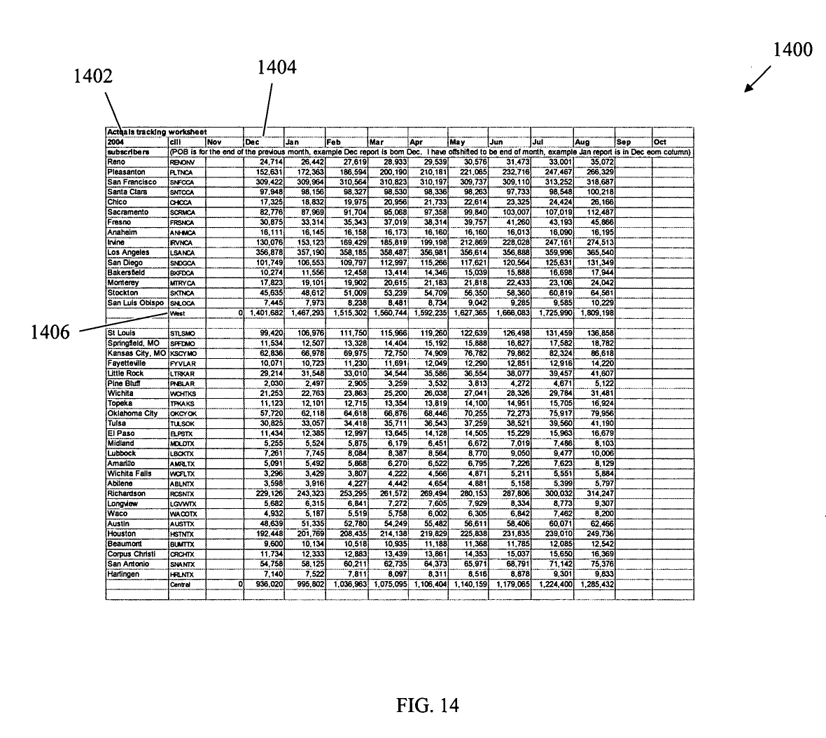

FIG. 14 illustrates an exemplary Actuals worksheet 1400. An Actuals worksheet displays actualized statistics related to growth, such as an actualized number of subscribers, a number of BRAS routers in use, an amount of OC3 circuitry being used, and associated costs. These statistics may be segmented according to wire center. Section 1402 shows one section of the Actuals worksheet in which the actualized number of subscribers per month are listed. The number of subscribers at each wire center are recorded by month 1404, and regional levels are recorded 1406 by month.

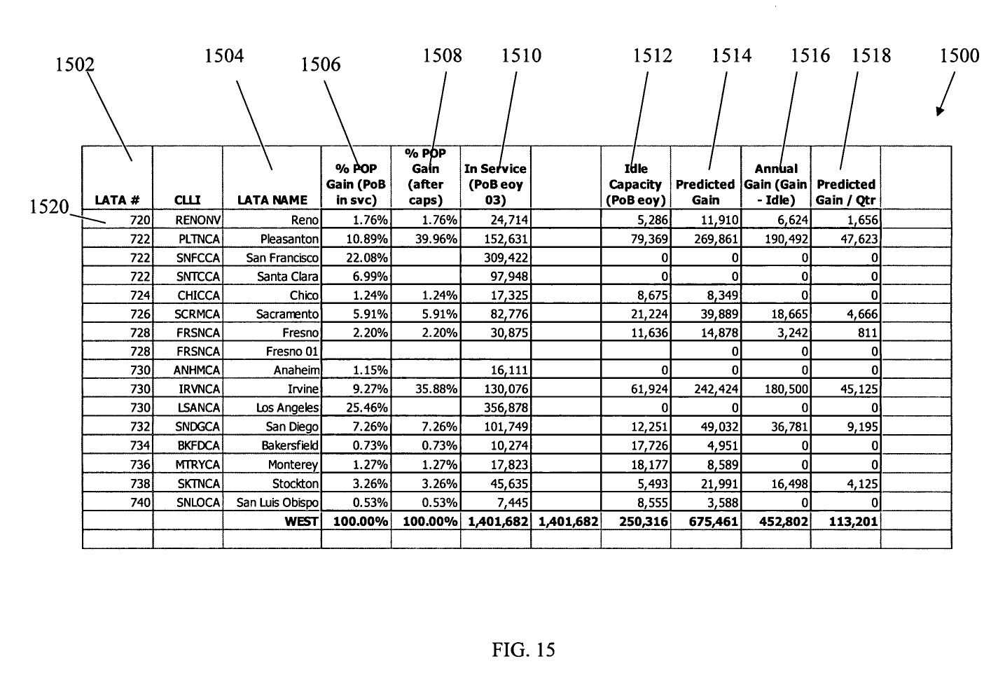

FIGS. 15-18 illustrates an exemplary Annual Growth worksheet 1500. The Annual Growth worksheet may be used to calculate regional network growth requirements. Using predicted growth rates along with current network conditions (i.e., number of present subscribers, number of existing BRAS routers, expected growth), the user may determine a number and type of new BRAS routers needed, associated costs, etc., at a given wire center. Section 1502, in FIG. 15, shows some projected statistics for customer growth per wire center. The values shown in row 1520 are discussed herein for illustrative purposes. Column 1504 displays a list of markets (i.e. Reno, Nev.). Column 1506 breaks down by percentage the amount each market is projected to contribute to overall subscriber growth. For instance, Reno is projected to contribute to 1.76% of total subscriber growth. Column 1510 displays a number of subscribers at the end of the previous calendar year (i.e., 24,714). Column 1512 displays an idle capacity, indicating the number of subscribers that may still be absorbed by the existing network (i.e., 5,286 for Reno). Column 1514 displays the number of subscribers that are projected to be gained in the coming year (i.e. 11,910 for Reno) given the percentage gain rate of column 1506. Column 1516 displays an Annual Gain, (the number of subscribers that are projected in excess of the capacity of the existing network). The Annual Gain is the difference between the gain of Column 1514 and the idle capacity of Column 1512. Column 1518, displays a quarterly expectation of projected gain (one-quarter of the value in column 1516).

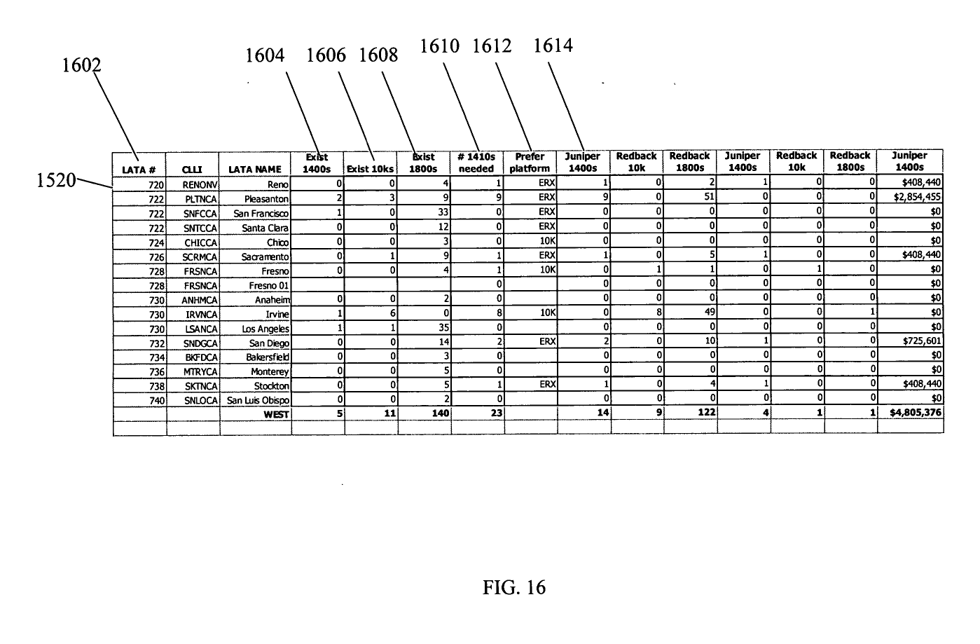

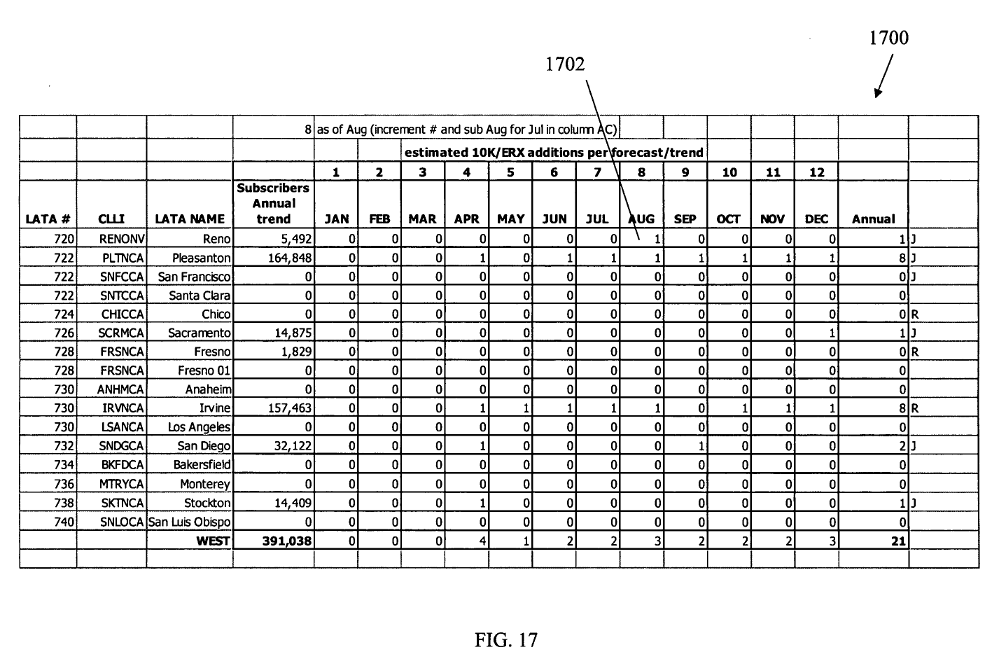

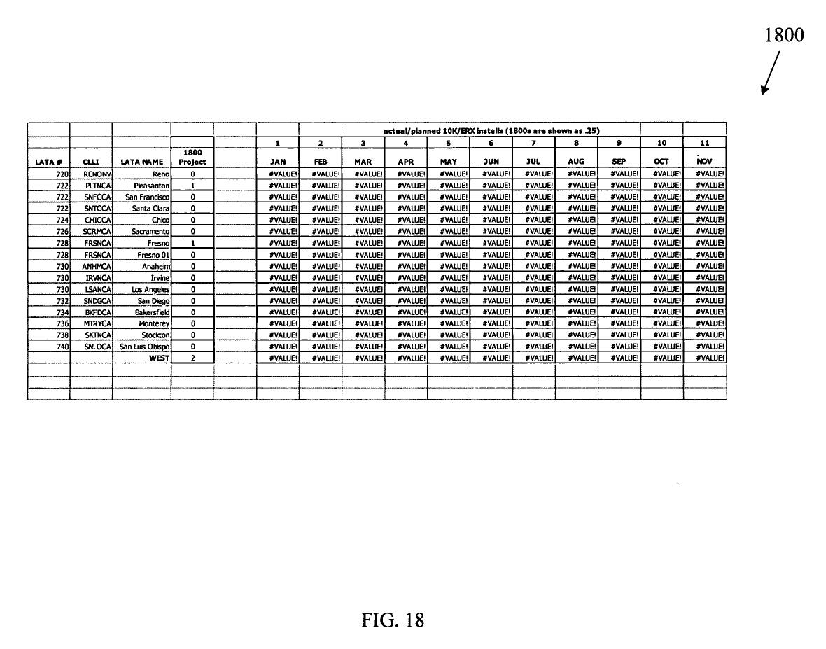

In FIG. 16, Section 1602 may be used in conjunction with Section 1502 of FIG. 15 and displays statistics for usage of BRAS routers. Columns 1604, 1606, and 1608 indicate the number of BRAS routers already in use in the indicated market. For example, using the illustration of Reno, there are 0 existing 1400 BRAS routers (column 1604), 0 existing 10k BRAS routers (column 1606), and 4 existing 1800 BRAS routers (column 1608). Column 1610 indicates a number of #1410 BRAS routers needed to implement the business plan (i.e. one #1410 BRAS router for Reno). The preferred platform is shown in column 1612. FIG. 17 shows a section 1700 for monthly projection for BRAS router implementation by POP. As an example, one router is implemented in July in Reno 1702. FIG. 18 shows a section 1800 for displaying an actualized implementation of the routers according to the business plan. Sections 1700 and 1800 may be used in conjunction with Section 1001. Monthly worksheets (not shown) follow the same structure as the Annual worksheets.

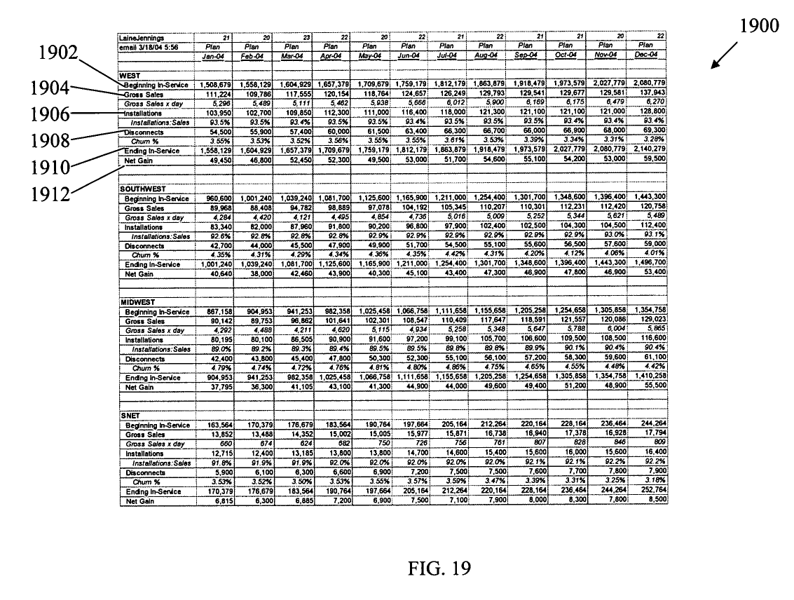

FIG. 19 illustrates an exemplary Forecast worksheet 1900 providing an initial estimate of growth in subscriber base used to derive projected growth parameters. The forecast is segmented according to regions and recorded by month. Each region tallies a beginning in-service number of subscribers 1902 (at the beginning of the month) and takes into account Gross Sales 1904, installations 1906 and disconnects 1908 to obtain an ending in-service number of subscribers (at the end of the month) 1910 and the consequent net gain 1912. The Forecast worksheet is used to create values in the Growth worksheet and to obtain number for BRAS growth rate, etc.

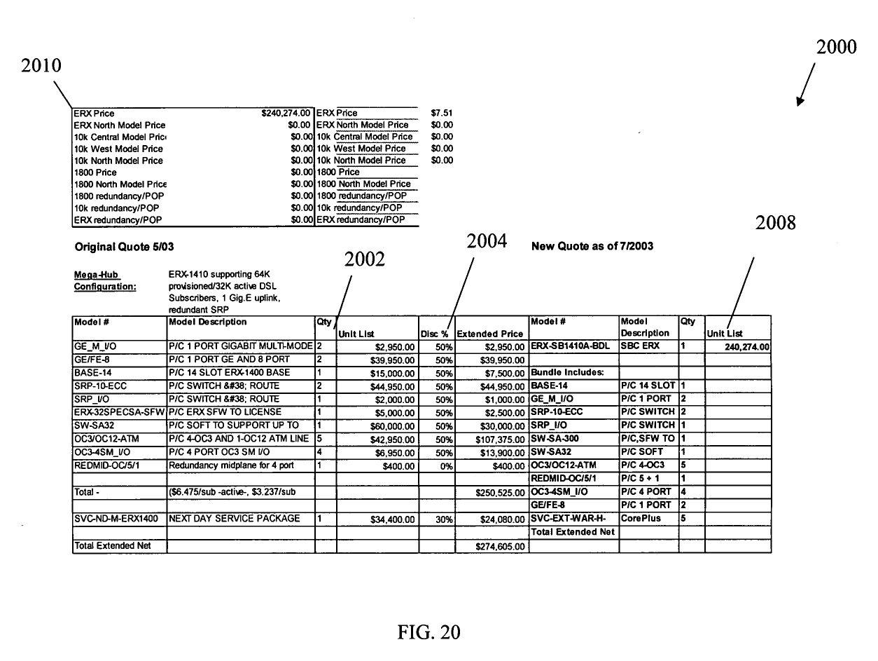

FIG. 20 illustrates a BRAS pricing worksheet 2000 providing purchasing costs of equipment used in a communications network. The BRAS pricing worksheet includes various cot models for BRAS routers. The cost model may be used as an input parameter in the business projection. The cost structures may be varied to accommodate changes that may occur due to market conditions, supplier discounts, etc. An operator of the present invention, for example, could change values on the cost of one of the BRAS items to determine the effect of a cost change on the company. Alternatively, an operator might start with a given total budget in mind and adjust prices of the equipment to determine a desired price that he might be willing to pay to maximize a bandwidth given the total budget. In the example of FIG. 20, a discounted rate (2004) is given and a calculation is made 2008 to determine a cost of a selected ERX BRAS bundle based on the quantities selected 2006. Calculations for multiple BRAS routers are summarized in Section 2010.

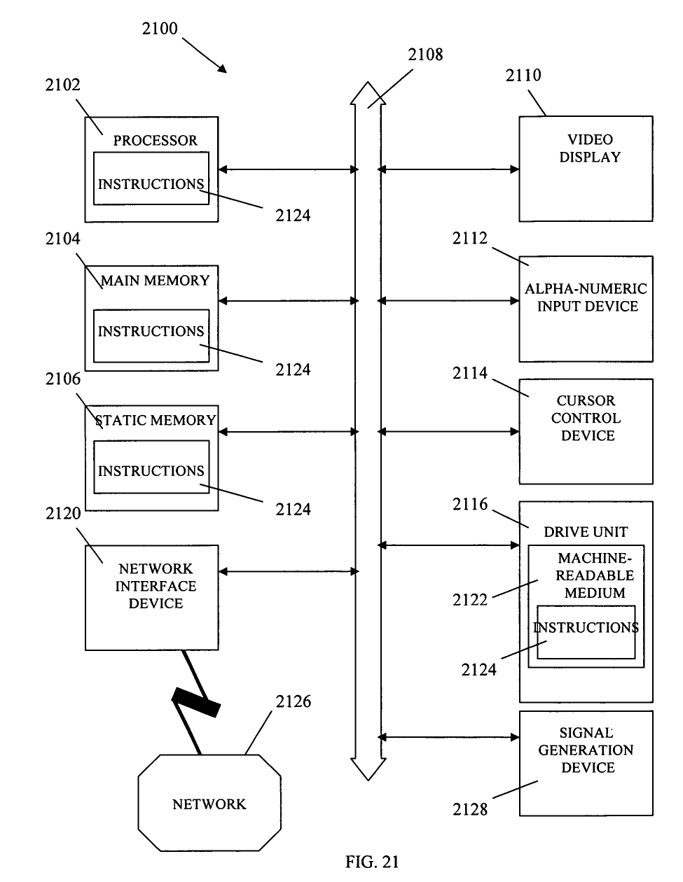

FIG. 21 is a diagrammatic representation of a machine in the form of a computer system 2100 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 2100 may include a processor 2102 (e.g., a central processing unit (CPU), a graphics processing unit (GPU), or both), a main memory 2104 and a static memory 2106, which communicate with each other via a bus 2108. The computer system 2100 may further include a video display unit 2110 (e.g., a liquid crystal display (LCD), a flat panel, a solid state display, or a cathode ray tube (CRT)). The computer system 2100 may include an input device 2112 (e.g., a keyboard), a cursor control device 2114 (e.g., a mouse), a disk drive unit 2116, a signal generation device 2118 (e.g., a speaker or remote control) and a network interface device 2120.

The disk drive unit 2116 may include a machine-readable medium 2122 on which is stored one or more sets of instructions (e.g., software 2124) embodying any one or more of the methodologies or functions described herein, including those methods illustrated in herein above. The instructions 2124 may also reside, completely or at least partially, within the main memory 2104, the static memory 2106, and/or within the processor 2102 during execution thereof by the computer system 2100. The main memory 2104 and the processor 2102 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present invention contemplates a machine readable medium containing instructions 2124, or that which receives and executes instructions 2124 from a propagated signal so that a device connected to a network environment 2126 can send or receive voice, video or data, and to communicate over the network 2126 using the instructions 2124. The instructions 2124 may further be transmitted or received over a network 2126 via the network interface device 2120.

While the machine-readable medium 2122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

The methods of the invention may be implemented utilizing a computer system, such as described in reference to FIG. 21, that includes a server, computer or processor that includes peripherals, including memory, visual displays, one or more databases and one or more computer programs in any suitable computer readable medium. In one aspect the system includes a computer readable medium containing a computer program accessible to a computer that executes a set of instructions. The computer program includes instructions to receive a forecast relating to a communications network and instructions to receive information relating to a plurality of network elements for use in the communications network, including capacity and cost to each network element instructions to receive at least one business rule, and instructions to generate a plurality of projections, including a projection for the network elements utilizing the forecast information relating to the plurality of network elements and the at least one business rule. The computer program may include instructions to receive a current inventory of the network elements and generate network element requirements over a period of time, including requirements for augmenting the current inventory of network elements. The computer program may further include instructions to receive a cost model and to provide a projection for costs for the projected network elements utilizing the cost mode, and instructions to generate a number of worksheets and visual displays. The worksheets may include a worksheet that shows capital expenditure over a selected time period, a worksheet that shows a trend, a worksheet that shows a projection of at least one of routers, servers, circuits that will meet the projected network elements, and a worksheet that provides comparison between actual usage of the network elements and the projected network element.

The computer readable program may further contain instructions to compare an actual parameter of the network to a parameter in the projections in the plurality of projections and provide information relating to a difference between the actual and the projection.

The method of the invention, in one aspect provides for managing elements of a communication network, wherein the method includes receiving a forecast, including a forecast relating to subscribers of a service, receiving a first inventory of network elements operating in the communications network, including a capacity relating to the network elements in the inventory, receiving a second inventory of network elements that are usable in the communication network, and determining a projection for the network elements from the second inventory of network elements that will meet the forecast utilizing a business rule.

The method may further provide a cost for the network elements of the projected network that will be needed to augment the inventory of network elements over selected time periods.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer readable medium containing a set of instructions accessible to a computer that executes the set of instructions, comprising:
instructions to receive a forecast relating to a communications network;
instructions to receive information relating to a plurality of network elements for use in the communications network, including capacity and cost relating to each network element;
instructions to receive at least one business rule; and
instructions to generate a plurality of projections, including a projection for the network elements utilizing the forecast, cost and at least one business rule.

2. The computer readable medium of claim 1 further comprising instructions to receive a current inventory of the network elements and generate a network element requirement over a period of time, including requirement for augmenting the current inventory of network elements.

3. The computer readable medium of claim 1, wherein a generated projection for the network elements includes a projection for one of routers, circuits, and servers.

4. The computer readable medium of claim 1 further comprising instructions to receive a cost model and to provide a projection for costs for the projected network elements utilizing the cost mode.

5. The computer readable medium of claim 1 further comprising instructions to generate a plurality of worksheets.

6. The computer readable medium of claim 5, wherein the worksheets in the plurality of worksheets are selected from a group consisting of: (i) a worksheet that shows capital expenditure over a selected time period, (ii) a worksheet that shows a trend, and (iii) a worksheet that shows a projection of at least one of routers, servers, circuits that will meet the projected network elements, and (iv) a worksheet that provides comparison between actual usage of the network elements and the projected network element.

7. The computer readable medium of claim 1 further comprising instructions to compare an actual parameter of the network to a parameter in the projections of the network elements and provide information relating to a difference between the actual parameter and a parameters in the projections of the network elements.

8. The computer readable medium of claim 7, wherein the parameter is one of cost, subscribers, routers, servers, circuits, and a geographical region.

9. A system, comprising:
a database storing a plurality of contents for a communications network, including contents for network elements for use in communications network, costs associated with each network element, and a forecast;
a processor having access to the database;
a computer readable medium accessible to the processor;
a computer program embedded in the computer readable medium, the computer program comprising;
instructions to receive the plurality of contents;
instructions to receive a forecast;
instructions to receive a business rule; and
instructions to generate a plurality of projections including a projection for the network elements and costs associated with the projection for the network element that is anticipated to meet the forecast.

10. The system of claim 9, wherein the projection for network elements is a projection for network elements in excess of a current inventory of the network elements.

11. The system of claim 1, wherein the database further includes a current inventory of network elements and wherein the computer program further comprises:
instructions to generate projections for expenditures to augment the current inventory to meet the forecast over selected periods of time.

12. The system of claim 1, wherein the computer program further comprises instructions to generate a plurality of worksheets, each worksheet in the plurality of worksheets relating to at least one parameter of the communications network.

13. The system of claim 9 further comprises instructions to determine utilization of the network elements.

14. The system of claim 9, wherein the forecast includes a forecast relating to subscribers of a network service and wherein the computer program further comprises instructions to generate a new plurality of projections when the forecast is changed.

15. The system of claim 9, wherein the computer program further comprises instructions to generate a worksheet that includes at least one of actual costs incurred, change in a number of subscribers, and change in the number of network elements.

16. A method for managing elements of a communication network, comprising receiving a forecast, including a forecast relating to subscribers of a service;
receiving a first inventory of network elements operating in the communications network, including a capacity relating to the network elements in the inventory;
receiving a second inventory of network elements that are usable in the communication network; and
determining a projection for the network elements from the second inventory of network elements that will meet the forecast utilizing a business rule.

17. The method of claim 16 further comprising providing a cost for the projected network elements from the second inventory of network elements over selected time periods.

18. The method of claim 16 further comprising comparing utilization of the network elements with a historical data to determine an effectiveness of the projections for the network elements.

19. The method of claim 18 further comprising, adjusting the plurality of projections based on historical data.

20. A method of creating a projection for implementing a communications network, comprising:
determining a state of a communications network;
applying a set of rules to technical and monetary parameters of network elements and to a forecast of customer activity to design a hardware configuration of the communications network; and
creating the projection for implementing changes in the communications network to meet the forecast of customer activity.

21. The method of claim 20, the forecast of customer activity further comprising a regional forecast of a number of subscribers.

22. The method of claim 20, wherein creating the projection further comprises providing a plan for implementing the communications network at a regional wire center.

23. The method of claim 20 further comprising comparing the projection to an actual outcome.
